(19) United States
(12) Patent Application Publication
(10) Pub. No.: US 2019/0370142 A1
(43) Pub. Date: Dec. 5, 2019

(54) DISPLAYING COMPUTING SYSTEM METRICS

(71) Applicant: Nutanix, Inc., San Jose, CA (US)

(72) Inventor: Uday Kiran JONNALA, San Ramon, CA (US)

(73) Assignee: Nutanix, Inc., San Jose, CA (US)

(21) Appl. No.: 16/038,583

(22) Filed: Jul. 18, 2018

Related U.S. Application Data
(63) Continuation-in-part of application No. 29/649,640, filed on May 31, 2018.

(51) Int. Cl. G06F 11/34; G06F 11/30; G06F 11/32

(52) U.S. Cl. CPC G06F 11/3409; G06F 11/328; G06F 11/3051

(57) ABSTRACT

Systems and methods for monitoring computing resource usage and computing task progression. The monitoring includes displaying computing system metrics by animating curved bands in a display screen. A method embodiment commences upon identifying computing system metrics that are associated with computing resource usage metrics and/or computing task progression metrics, then assigning one or more curved bands to the computing resource usage and/or computing task progression metrics. The curved bands are configured to be displayed in a user interface. The curved band configuration includes determining graphical characteristics of the curved bands, where the graphical characteristics are determined based on aspects of the system metrics. State parameter values corresponding to the system metrics change over time, which changes are animated by displaying changes via the graphical characteristics of the one or more curved bands to visually indicate usage and/or progress. A user manipulates certain of the graphical characteristics from the user interface.

### RELATED APPLICATIONS

The present application is a continuation-in-part of, and claims the benefit of priority to co-pending U.S. Patent Application Ser. No. 29/649,640 titled “PROGRESS VISUALIZATION FOR A DISPLAY SCREEN OR PORTION THEREOF”, filed May 31, 2018, which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

This disclosure relates to computing systems, and more particularly to techniques for displaying computing system metrics.

### BACKGROUND

Modern computing environments are designed to facilitate scaling of computing resources as demands change. As the size and complexity of such computing environments continue to increase, users (e.g., system administrators) have an increased need to monitor certain characteristics of the computing environment. One category of such characteristics pertains to resource demands in the computing environment (e.g., resource usage, etc.). As examples, a user may want to view (e.g., in a dashboard of a user interface) a plurality of system metrics (e.g., CPU usage, memory usage, disk usage, etc.) that represent the historical and/or then-current states (e.g., measured usage) of a set of computing resources. Another category of computing environment characteristics pertains to the states of computing processes being executed in the environment. Such computing process states often indicate the level of progression (e.g., from the start of the process to the completion of the process) that is achieved by a particular computing process. Some computing processes may execute from start to finish within a few a second or less, while other computing processes may execute from start to finish over a longer period of time. While these computing processes are executing, users often want to see one or more system metrics that indicate the progression achieved by the processes. For example, a system administrator may want to view a depiction of the progression as a graphical element that displays some indication of a “percent completed” system metric associated with a particular computing process.

Varying techniques can be selected in computing environments to present the state of the foregoing system metrics. Some such techniques for depicting a state or progression present system metric observations in the form of rectangular-shaped graphical elements (e.g., bars). As examples, the changing state (e.g., the progress) of a computing task might be presented in a changing “progress bar” graphical element, or the changing states of a set of computing resources might be presented in a “bar chart” that indicates the respective percentage utilized of each resource. Such bar-shaped graphical elements often have a visually-identifiable start and a visually-identifiable end. Various graphical characteristics (e.g., colors, fills, transparency levels, labels, etc.) are implemented to present a visualization of the progression or utilization in the bars.

Unfortunately, the foregoing approaches for displaying system metrics have become deficient in the context of modern computing environments. For example, while variations of the foregoing “progress bar” or “bar chart” approaches might be useful for displaying a single metric, these approaches consume a large portion of a display area, especially when concurrently presenting the states of multiple system metrics. In cases where display space is limited, several interrelated metrics (e.g., several processes that together achieve a particular function) might be presented as a single consolidated metric. However, merely displaying the state of a single consolidated metric (e.g., in a single progress bar) results in an occlusion of details pertaining to the states of the underlying metrics. Furthermore, such approaches using bar-shaped graphical elements often normalize the displayed metrics so as to efficiently fill a limited display area with bars that have the same length. When presenting the state of heterogenous system metrics using such normalized bars, the resulting visualization can be misleading to a user. For example, in a normalized bar chart, a first bar indicating a 10-second task is 50 percent complete, will have similar graphical characteristics as a second bar indicating a 2-minute task is 50 percent complete, but the time to complete each task is substantially different. An improved technique is needed for efficiently displaying the states of multiple heterogenous computing system metrics.

### SUMMARY

The present disclosure describes techniques used in systems, methods, and in computer program products for displaying computing system metrics, which techniques advance the relevant technologies to address technological issues with legacy approaches. More specifically, the present disclosure describes techniques used in systems, methods, and in computer program products for using curved bands to display computing system metrics. Certain embodiments are directed to technological solutions for assigning computing system metrics to curved bands having graphical characteristics that represent the states of the metrics.

The disclosed embodiments modify and improve over legacy approaches. In particular, the herein-disclosed techniques provide technical solutions that address the technical problems attendant to compactly displaying the states of multiple heterogenous computing system metrics. Such technical solutions relate to improvements in computer functionality. Some embodiments disclosed herein use techniques to improve the functioning of multiple systems within the disclosed environments, and some embodiments advance peripheral technical fields as well. As specific examples, use of the disclosed computer equipment, networking equipment, and constituent devices within the shown environments as described herein and as depicted in the figures provide advances in the technical field of human-machine interface as well as advances in various technical fields related to computing system management.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1 illustrates a computing environment in which embodiments of the present disclosure can be implemented.

FIG. 2 depicts a computing system metric display technique as implemented in systems that use curved bands to display computing system metrics, according to an embodiment.

FIG. 3 presents a curved band configuration technique as implemented in systems that use curved bands to display computing system metrics, according to an embodiment.

FIG. 4 presents a metric state processing technique as implemented in systems that use curved bands to display computing system metrics, according to an embodiment.

FIG. 5A presents a curved band display scenario as implemented in systems that use curved bands to display computing system metrics, according to an embodiment.

FIG. 5B and FIG. 5C present a curved band subcomponent drill down scenario as implemented in systems that use curved bands to display computing system metrics, according to an embodiment.

FIG. 6 presents a distributed virtualization environment in which embodiments of the present disclosure can be implemented.

FIG. 7 depicts system components as arrangements of computing modules that are interconnected so as to implement certain of the herein-disclosed embodiments.

FIG. 8A, FIG. 8B, and FIG. 8C depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of compactly displaying the states of multiple heterogenous computing system metrics. Some embodiments are directed to approaches for assigning computing system metrics to curved bands having graphical characteristics that represent the states of the metrics. The accompanying figures and discussions herein present example environments, systems, methods, and computer program products for using curved bands to display computing system metrics.

### Overview

Disclosed herein are techniques for assigning computing system metrics to curved bands having graphical characteristics that are representative of the states of the metrics. In certain embodiments, a set of system metrics that are associated with a computing system are identified. For example, the system metrics might pertain to the computing resources of the computing system and/or the processes executed at the computing system. In response to a metric view request (e.g., a dashboard launch), some or all of the identified system metrics are respectively assigned to a set of curved bands. Certain graphical characteristics of the curved bands are determined based at least in part on the then-current states of the identified system metrics, which states are representative of the states of the underlying computing resources or processes. For example, the graphical characteristics of a particular curved band that corresponds to a process might indicate a point between the beginning and end of the curved band that represents the state of the process with respect to a predicted completion state. The curved bands with their associated graphical characteristics are displayed in a user interface. In certain embodiments, the system metrics are assigned to the curved bands based at least in part on various attributes of the system metrics and/or the curved bands. In certain embodiments, one or more of the system metrics is associated with a set of underlying system metrics that can be displayed according to the herein disclosed techniques. Graphical characteristics of the curved bands are changed in synchronicity with ongoing changes in the states of corresponding system metrics,

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

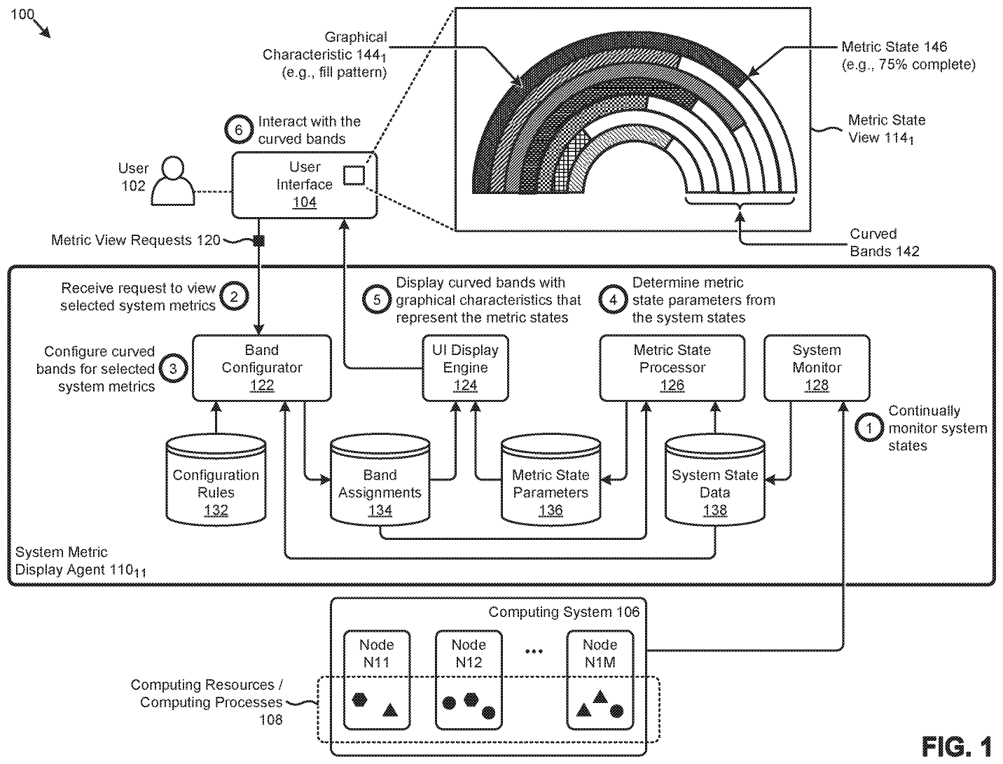

FIG. 1 illustrates a computing environment 100 in which embodiments of the present disclosure can be implemented. As an option, one or more variations of computing environment 100 or any aspect thereof may be implemented in the context of the architecture and functionality of the embodiments described herein.

FIG. 1 illustrates one aspect pertaining to assigning computing system metrics to curved bands having graphical characteristics that represent the states of the metrics. Specifically, the figure presents a logical depiction of how the herein disclosed techniques can be implemented in a computing environment to display various system metrics associated with the computing environment in a user interface that comprises a set of curved bands.

The logical depiction of FIG. 1 illustrates a computing system 106 that comprises multiple computing nodes (e.g., node N11, node N12, . . . , node N1M). Such nodes can comprise various computing resources that are implemented and/or scaled to execute certain computing processes. Certain users (e.g., user 102) of computing system 106 have a need to monitor such heterogeneous computing resources and/or computing processes (e.g., computing resources/computing processes 108). For example, a system administrator might want to visualize (e.g., in a user interface 104) a plurality of system metrics that represent the then-current and/or changing state of a selected set of computing resources and/or computing processes, so as to facilitate management of the computing system 106. The richness of information associated with such visualizations can be enhanced by presenting the states as compared to a static state or states, such as the start and completion of a task, or a range of usage of a resource. In some approaches, rectangular-shaped graphical elements (e.g., bars) are used to display such relative states. As examples, system metrics that represent the changing state (e.g., the progress) of a computing task might be displayed in a changing “progress bar” graphical element, or system metrics that represent the changing states of a set of computing resources might be presented in a “bar chart” that indicates the respective percentage utilized of each resource. However, in modern computing systems that have large numbers of heterogenous computing resources and/or computing processes, these and other approaches to displaying the corresponding heterogeneous system metrics can be deficient. Specifically, approaches that use bar-shaped graphical elements can consume large portions of a display area, and/or can lead to visualizations that lack certain detail or mislead the users.

The herein disclosed techniques address such challenges pertaining to displaying the states of multiple heterogenous computing system metrics by implementing a system metric display agent 110₁₁ in computing environment 100. A system monitor 128 at the system metric display agent 110₁₁ is configured for continually monitoring the state of computing system 106 (operation 1) and for storing state observations pertaining to the computing resources and/or computing processes. As shown, the state observations are stored in a set of system state data 138. Various instances of metric view requests 120 to view selected system metrics might be received at a band configurator 122 operating at the system metric display agent 110₁₁ (operation 2). For example, a metric view request might be issued when user 102 launches a dashboard view in a browser at user interface 104. In this case, the dashboard view might be configured to present a selected collection of system metrics for the user (e.g., a system administrator) to analyze. The band configurator 122 processes the received request parameters to configure a set of curved bands for the selected system metrics (operation 3). In some cases, an instance of a particular type of curved band is assigned to each of the selected system metrics based at least in part on a set of configuration rules 132 and/or the various attributes of the respective system metrics. Various attributes (e.g., scale, color, fill, band order, length, etc.) of assigned curved bands are determined at the band configurator 122. For example, certain historical information at system state data 138 might be accessed by band configurator 122 to determine a predicted duration of a task associated with a particular system metric, which predicted duration can be used to determine one or more scale attributes of the curved band associated with the system metric. The band-metric pairs and associated attributes are recorded in a set of band assignments 134.

A metric state processor 126 at system metric display agent 110₁₁ accesses the system state data 138 to determine instances of metric state parameters 136 associated with the selected system metrics (operation 4). As shown, metric state processor might access the band assignments 134 to identify the then-current set of system metrics that are being or are to be displayed. The metric state parameters 136 are structured and/or organized for processing by a UI display engine 124 at system metric display agent 110₁₁. The UI display engine 124 combines the metric state parameters 136 and the band assignments 134 to display the curved bands with graphical characteristics that represent the metric state parameters of the selected system metrics (operation 5). As shown in metric state view 114₁, a graphical characteristic 144₁ associated with the outermost curved band of the depicted set of seven curved bands 142 might be a fill pattern that fills a portion of the curved band to indicate a metric state 146 as being 75 percent complete. In some cases, user 102 might interact with one or more of the curved bands (operation 6). For example, user 102 can click on a curved band assigned to a particular system metric associated with a high level operation to invoke the display of another set of curved bands that present the states of the underlying tasks that comprise the operation.

The system metric display capability facilitated by the herein disclosed techniques compactly displays the states of multiple heterogenous computing system metrics. As such, application of the techniques disclosed herein facilitate improvements in computer functionality that serve to reduce the demand for computer memory, reduce the demand for computer processing power, reduce network bandwidth use, and reduce the demand for inter-component communication. Specifically, displaying the state or changing state (e.g., progress) of system metrics using curved bands reduces the screen area required to display the metrics, thereby reducing the consumption of computing resources to generate, present, or otherwise process multiple metric state views.

One embodiment of techniques for displaying computing system metrics is disclosed in further detail as follows.

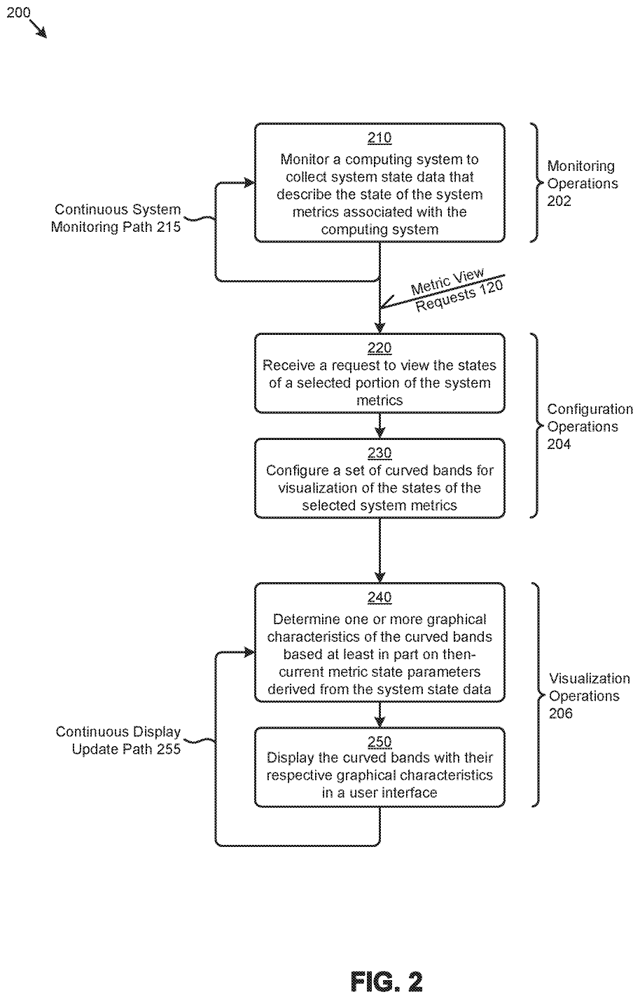

FIG. 2 depicts a computing system metric display technique 200 as implemented in systems that use curved bands to display computing system metrics. As an option, one or more variations of computing system metric display technique 200 or any aspect thereof may be implemented in the context of the architecture and functionality of the embodiments described herein. The computing system metric display technique 200 or any aspect thereof may be implemented in any environment.

FIG. 2 illustrates one aspect pertaining to assigning computing system metrics to curved bands having graphical characteristics that represent the states of the metrics. Specifically, the figure presents one embodiment of certain steps and/or operations that facilitate assigning computing system metrics to curved bands that are configured to have graphical characteristics that represent the states of the metrics. As shown, such steps and/or operations can constitute a set of monitoring operations 202, a set of configuration operations 204, and a set of visualization operations 206.

The monitoring operations 202 of the computing system metric display technique 200 can commence by monitoring a computing system to collect various system state data that describe the state of the system metrics associated with the computing system (step 210). The system metrics might indicate the states of various computing resources and/or computing processes (e.g., tasks) associated with the computing system. As indicated by a continuous system monitoring path 215, the monitoring of the computing system can be a continuous operation.

The configuration operations 204 of the computing system metric display technique 200 can commence by receiving a request (e.g., from metric view requests 120) to view the state or states of a selected portion of the system metrics being monitored (step 220). For example, a particular metric view request might pertain to system metrics associated with the computing resources (e.g., virtual machines, physical memory, virtual disks, etc.) corresponding to a computing node of a computing cluster. As another example, a metric view request might pertain to a collection of tasks associated with a virtual machine migration operation. A set of curved bands that correspond to the any of the foregoing sets of selected system metrics are configured for visualization of the selected system metrics (step 230).

As part of the visualization operations 206 of the computing system metric display technique 200, one or more graphical characteristics of the curved bands are determined based at least in part on the then-current metric state parameters derived from the system state data (step 240). For example, a certain color might be assigned to a portion of a curved band to indicate the then-current progress of a task as compared to the start state and completion state of the task. The curved bands and their respective graphical characteristics are then displayed in a user interface (step 250). As indicated in a continuous display update path 255, the steps and/or operations of determining and presenting the graphical characteristics of the curved bands are continually performed. As such, a user can observe the dynamically changing states (e.g., task progress, utilization fluctuations, etc.) of the system metrics.

The foregoing discussions include techniques for configuring the curved bands that are associated with certain system metrics (e.g., step 230 of FIG. 2), which techniques are disclosed in further detail as follows.

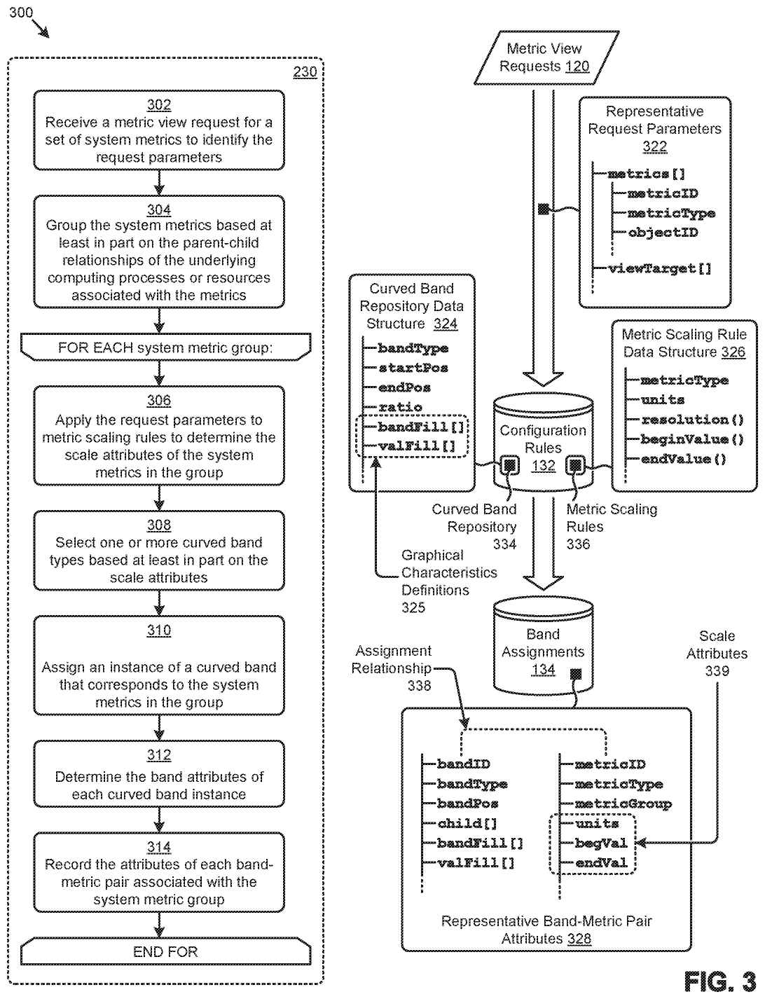

FIG. 3 presents a curved band configuration technique 300 as implemented in systems that use curved bands to display computing system metrics. As an option, one or more variations of curved band configuration technique 300 or any aspect thereof may be implemented in the context of the architecture and functionality of the embodiments described herein. The curved band configuration technique 300 or any aspect thereof may be implemented in any environment.

FIG. 3 illustrates one aspect pertaining to assigning computing system metrics to curved bands having graphical characteristics that represent the states of the metrics. Specifically, the figure is being presented to illustrate one embodiment of certain steps and/or operations for configuring a set of curved bands for visualization of certain system metrics according to the herein disclosed techniques. The figure further illustrates one embodiment of the data structures of the data sets (e.g., metric view request parameters, configuration rules, band assignments, etc.) that are accessed and/or populated in conjunction with configuring the curved bands.

The data sets described herein can be organized and/or stored using various techniques. Specifically, the data structures corresponding to the data sets shown in FIG. 3 are designed to improve the way a computer stores and retrieves data in memory when performing steps and/or operations pertaining to the use of curved bands to display computing system metrics. For example, the data records comprising such data sets might be organized and/or stored in a tabular structure (e.g., relational database table) that has rows that relate various attributes (e.g., each in a respective column) that pertain to a particular entity. As another example, the information might be organized and/or stored in a programming code object that has instances corresponding to a particular entity and properties corresponding to the various attributes associated with the entity.

The data sets and corresponding data structures described herein are used by the curved band configuration technique 300 as follows. A metric view request (e.g., from metric view requests 120) associated with a set of system metrics is received and then parsed to identify a set of request parameters (step 302). As indicated in a set of representative request parameters 322, a set of such request parameters (e.g., object instance) for a metric view request might describe certain attributes associated with each of the system metrics (e.g., stored in a “metrics []” object), such as a metric identifier (e.g., stored in a “metricID” field), a metric type (e.g., stored in a “metricType” field), an identifier corresponding to the underlying computing resource or computing process associated with the metric (e.g., stored in an “objID” field), and/or other attributes. The “objID” might be used to access a rich set of information (e.g., task identifiers, resource entity identifiers, download target, download bytes, usage thresholds, etc.) pertaining to the underlying computing resources or computing processes. The request parameters might also include certain attributes pertaining to the view target associated with the request (e.g., stored in a “viewTarget []” object). For example, the view target attributes might comprise a target view area (e.g., height and/or width in pixels), an HTML “div” identifier, an HTML “div” class or style, and/or other attributes.

The foregoing request parameters and/or other information are accessed to group the system metrics based at least in part on the parent-child relationships of the underlying computing processes or computing resources associated with the system metrics (step 304). In some cases, the “objID” parameter specified for a particular system metric in the request parameters might be used to identify any child and/or parent objects (e.g., computing processes or computing resources) and their respective system metrics that are associated with the particular system metric. Strictly as an example, a progress metric (e.g., “parent” metric) for a node backup operation might be associated with the progress metrics (e.g., “child” metrics) of several underlying tasks (e.g., the backup of each virtual machine and virtual disk at the node). As another example, a health metric (e.g., “parent” metric) for a particular computing node might be associated with any number of utilization metrics (e.g., “child” metrics) of the underlying computing resources of the node. In such cases, the child metrics can be grouped (e.g., so as to form associations with a respective parent metric).

For each of the system metric groups, the request parameters of the system metrics in the groups are applied to a set of metric scaling rules to determine the scale attributes of the system metrics (step 306). The scale attributes can in turn be used for determining a band assignment, and/or for a range of values to be displayed, and/or for determining display resolution markings, numeric minimums/maximums, etc.

As illustrated, a set of metric scaling rules 336 might be organized and/or stored in the configuration rules 132 in accordance with a metric scaling rule data structure 326. A set of rules (e.g., rule base) such as metric scaling rules 336 or any other rules described herein, comprises data records storing various information that can be used to form one or more constraints to apply to certain functions and/or operations. For example, the information pertaining to a rule in the rule base might comprise the conditional logic operands (e.g., input variables, conditions, constraints, etc.) and/or operators (e.g., “if”, “then”, “and”, “or”, “greater than”, “less than”, etc.) for forming a conditional logic statement that returns one or more results. As indicated by the metric scaling rule data structure 326, a data record (e.g., table row or object instance) for a particular metric scaling rule might relate a certain type of system metric (e.g., stored in a “metricType” field) to, a description of the units for the system metric (e.g., stored in a “units” field), a function for determining the scale resolution of the system metric (e.g., accessed by a “resolution ( )” function call), a function for determining the minimum scale value of the system metric (e.g., accessed by a “beginValue ( )” function call), a function for determining the maximum scale value of the system metric (e.g., accessed by a “endValue ( )” function call), and/or other items related to the type of system metric. The metric scaling rules 336 can be accessed to determine the scale attributes of a variety of system metrics. For example, a system metric to monitor the state (e.g., progress) of a file download task might look at the underlying task information (e.g., referenced by the content of the “objID” request parameter) to determine the number of bytes to be downloaded, and use that information to establish certain scale attributes according to the “resolution ( )”, “beginValue ( )”, and “endValue ( )” functions for that particular metric type. As another example, historical system state data might be applied to the “resolution ( )”, “beginValue ( )”, and “endValue ( )” functions to determine the scale attributes. Specifically, the average time to complete a certain type of task as determined from the historical system state data might be used to establish an end value (e.g., predicted completion time). The foregoing attributes (e.g., units, scale resolution, minimum scale value, maximum scale value, etc.) as determined based at least in part on metric scaling rules 336 are examples of scale attributes.

Such scale attributes and/or other information are used to select one or more curved band types (step 308). For example, the curved band types might be selected from a curved band repository 334 stored in configuration rules 132 in accordance with a curved band repository data structure 324. As depicted by the curved band repository data structure 324, a data record (e.g., table row or object instance) for a particular curved band type might comprise a description of the curved band type (e.g., stored in a “bandType” field), an indication of the band start position to correspond to a first end of the band (e.g., a value in degrees stored in a “startPos” field), an indication of the band end position to correspond to a second end of the band (e.g., a value in degrees stored in an “endPos” field), an indication of the band curvature or aspect ratio (e.g., stored in a “ratio” field), a set of default band fill attributes (e.g., stored in a “bandFill []” object), a set of value fill attributes for the portion of the curved band that represents a then-current metric state (e.g., stored in a “valFill []” object), and/or other attributes. As illustrated, the “bandFill []” object and the “valFill []” object of a particular curved band type might comprise a set of graphical characteristics definitions 325 that define, at least in part, the graphical characteristics of a curved band that are implemented by the herein disclosed techniques to represent the metric state parameters of the system metrics. In some cases, one curved band type might be selected for all of the system metrics in the system metric group. In other cases, multiple curved band types might be selected for the system metric group. As merely examples, a first curved band type having a shorter length (e.g., as indicated by the band start and end positions) might be selected for lower resolution metric types, and a second band type having a longer length might be selected for high resolution metric types.

Instances of curved bands that correspond to the selected curved band types are assigned to each of the system metrics in the subject system metric group (step 310). Various band attributes for the assigned curved bands are determined (step 312). For example, specific colors, fill patterns, and/or other band attributes are determined based at least in part on any of the earlier described data sets and/or other information. The attributes of each band-metric pair of the system metric group are recorded (step 314). As can be observed, such attributes can be stored in band assignments 134. A set of representative band-metric pair attributes 328 indicate a data record (e.g., table row or object instance) stored in band assignments 134 might describe a curved band identifier (e.g., stored in a “bandID” field, a description of the curved band type (e.g., stored in a “bandType” field), an indication of the position of a curved band in a set of curved bands (e.g., stored in a “bandPos” field), a list of any child groups associated with the curved bands (e.g., stored in a “child []” object), a set of default band fill attributes (e.g., stored in a “bandFill []” object), a set of value fill attributes for the portion of the curved band that represents a then-current metric state (e.g., stored in a “valFill []” object), a metric identifier (e.g., stored in a “metricID” field), a metric type (e.g., stored in a “metricType” field), a description of the group comprising the system metric (e.g., stored in a “metricGroup” field), a description of the units for the system metric (e.g., stored in a “units” field), a minimum scale value of the system metric (e.g., stored in a “begVal” field), a maximum scale value of the system metric (e.g., stored in an “endVal” field), and/or other attributes of the band-metric pair. As shown, an assignment relationship 338 between the curved band and the system metric of a band-metric pair is codified in the “banded” and “metricID” of a particular data record. The scale attributes 339 of a particular band-metric pair is also represented at least in part by the “units”, “begVal”, and “endVal” attributes of the band-metric pair.

The foregoing discussions include techniques for processing metric state information to determine certain graphical characteristics of curved bands used to display system metrics (e.g., step 240 of FIG. 2), which techniques are disclosed in further detail as follows.

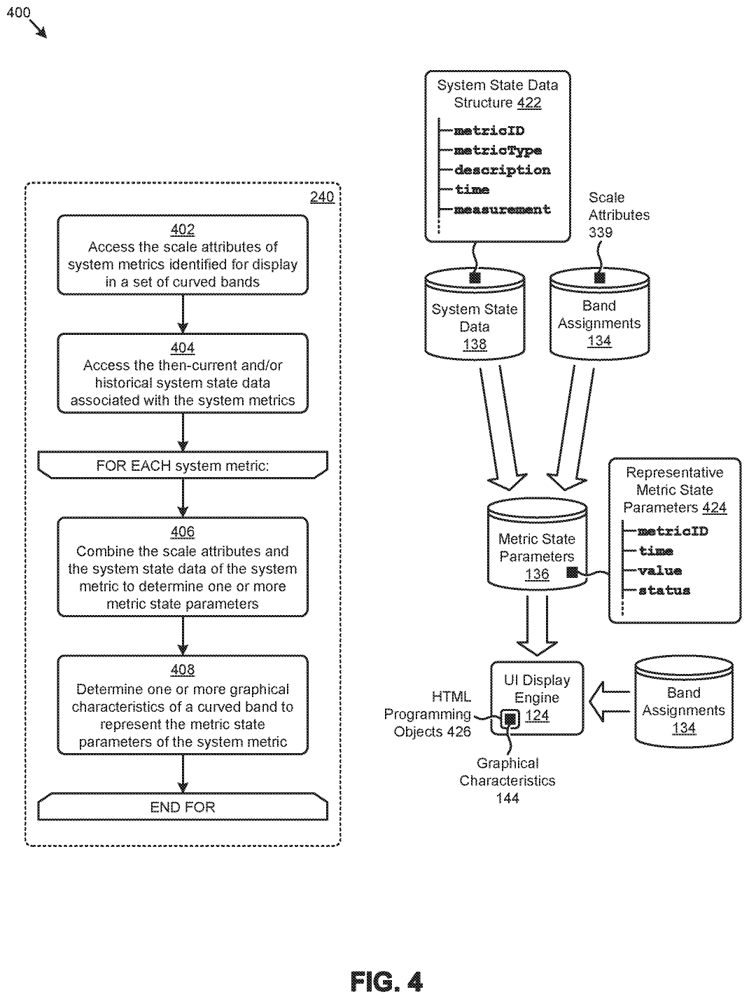

FIG. 4 presents a metric state processing technique 400 as implemented in systems that use curved bands to display computing system metrics. As an option, one or more variations of metric state processing technique 400 or any aspect thereof may be implemented in the context of the architecture and functionality of the embodiments described herein. The metric state processing technique 400 or any aspect thereof may be implemented in any environment.

FIG. 4 illustrates one aspect pertaining to assigning computing system metrics to curved bands having graphical characteristics that represent the states of the metrics. Specifically, the figure is being presented to illustrate one embodiment of certain steps and/or operations for determining one or more graphical characteristics of a set of curved bands used to display system metrics according to the herein disclosed techniques. The figure also presents an example scenario to further illustrate an application of the steps and/or operations shown in FIG. 4.

The metric state processing technique 400 can commence by accessing the scale attributes of system metrics that are identified (e.g., in a metric view request) for display in a set of curved bands (step 402). For example, the scale attributes 339 of the band-metric pairs attributes stored at band assignments 134 might be accessed. The then-current and/or historical system state data associated with the system metrics are also accessed (step 404). As shown, the accessed data might be stored in system state data 138 in accordance with a system state data structure 422. As depicted by the system state data structure 422, a data record (e.g., table row or object instance) stored in system state data 138 for a particular system metric might comprise a metric identifier (e.g., stored in a “metricID” field), a metric type (e.g., stored in a “metricType” field), a description of the metric (e.g., stored in a “description” field), a timestamp corresponding to the moment in time the state is recorded (e.g., stored in a “time” field), a state observation value or measurement value (e.g., stored in a “measurement” field), and/or other data.

For each system metric identified for viewing, the respective scale attributes and system state data are combined to determine one or more metric state parameters (step 406). As illustrated in a set of representative metric state parameters 424 stored in metric state parameters 136, a then-current metric value (e.g., stored in a “value” field) and a then-current metric status (e.g., stored in a “status” field) might be generated for a particular system metric (e.g., as identified in a “metricID” field) at a particular moment in time (e.g., as specified in a “time” field). The then-current metric “value” parameter is a numerical value pertaining to the system metric, whereas the then-current metric “status” is a characterization of the trend of the system metric and/or the underlying computing process or resource. For example, the most recent system state data entry for a particular system metric might translate to a “value” parameter of “75” (e.g., percent completed), and the last ten historical entries might indicate the metric “status” can be characterized as “progressing”. Other “status” types include “completed”, “blocked”, “stranded”, and/or other types. In some cases, the value and/or status of a particular system metric (e.g., of a higher order operation) might be determined (e.g., consolidated) from the values and/or statuses of one or more underlying system metrics (e.g., of one or more lower order tasks).

Referring again to the steps and/or operations of metric state processing technique 400, one or more graphical characteristics of a curved band associated with the system metric are determined to represent at least one of the metric state parameters of the system metric (step 408). For example, the graphical characteristics might include a fill pattern and/or color that is applied to a portion (e.g., 75 percent) of the curved band that is equal to the portion of a task that is completed, or equal to the portion of a maximum usage level of a resource that is utilized. As illustrated in FIG. 4, the UI display engine 124 might consume the metric state parameters 136 and attributes (e.g., band attributes, scale attributes, etc.) of the band assignments 134 to generate a set of graphical characteristics 144 for the curved bands of each of the system metrics identified for display. In some cases, the graphical characteristics 144 might be codified in a set of HTML programming objects 426 (e.g., screen devices, widgets, GIF images, etc.).

The foregoing discussions include techniques for displaying curved bands with respective graphical characteristics to visualize system metrics in a user interface (e.g., step 250 of FIG. 2), which techniques are disclosed in further detail as follows.

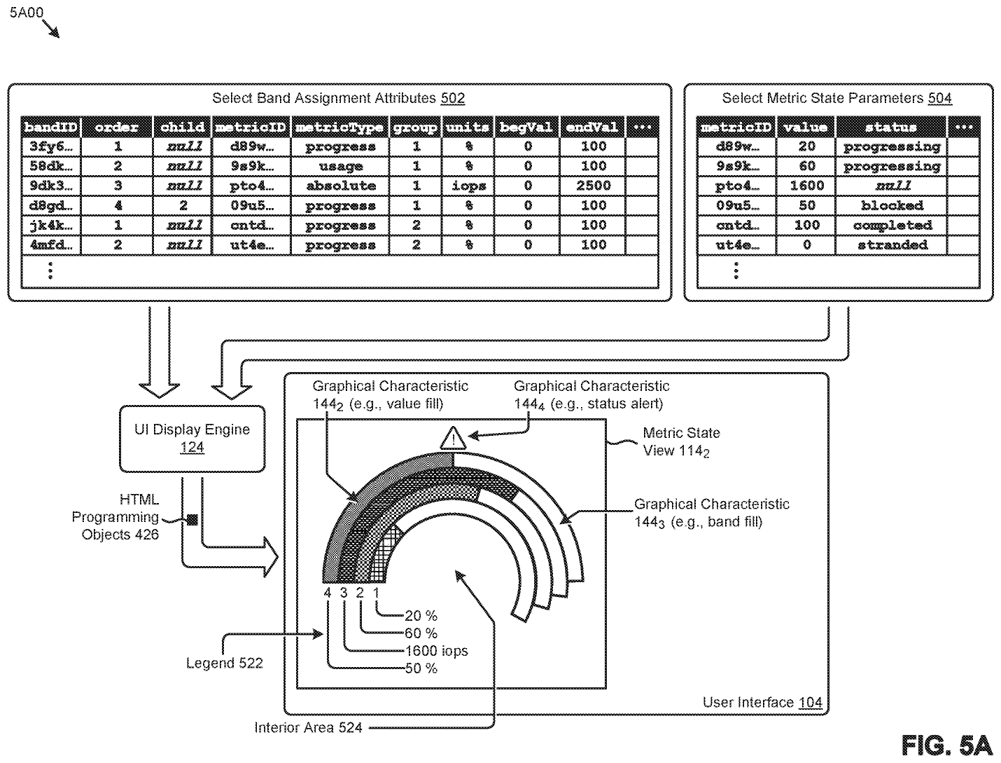

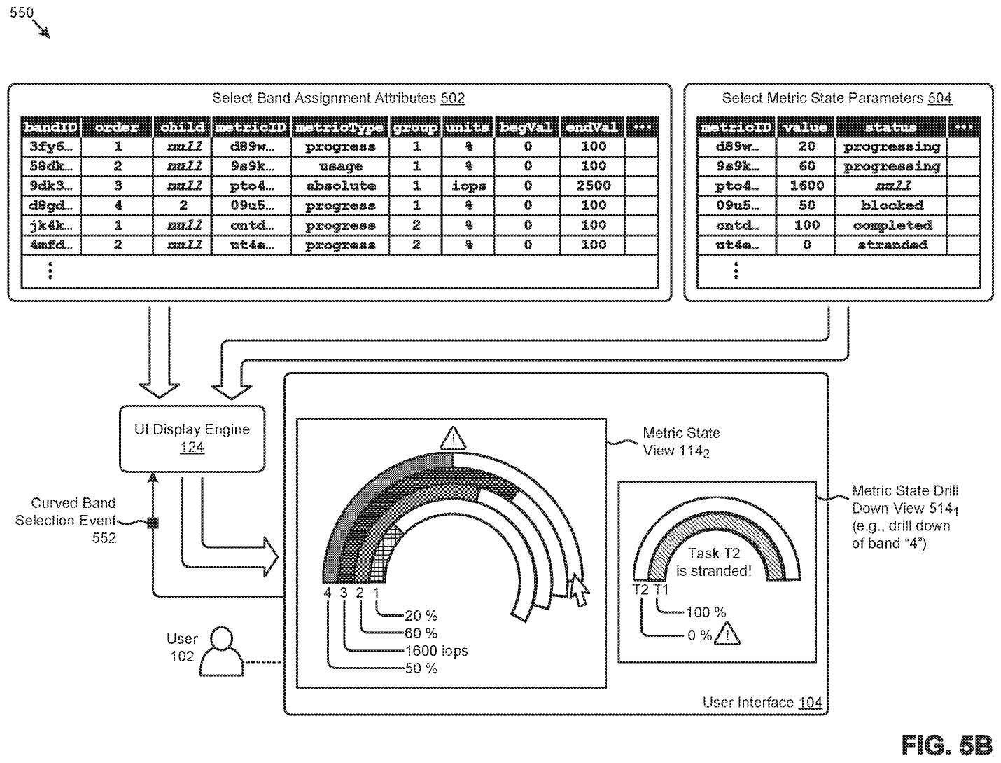

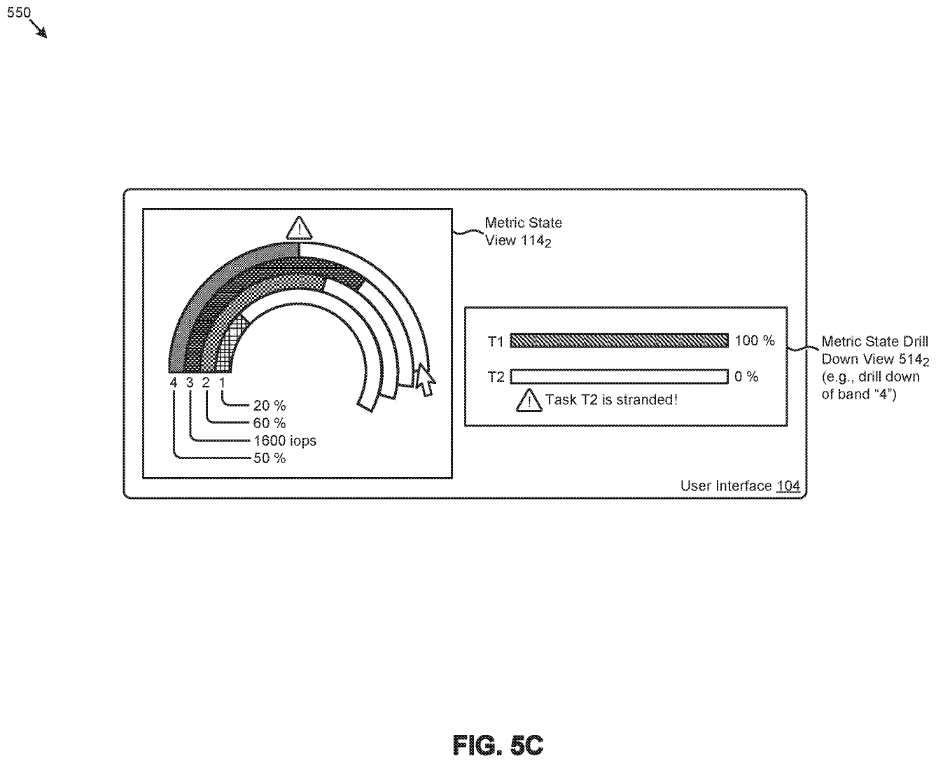

FIG. 5A presents a curved band display scenario 5A00 as implemented in systems that use curved bands to display computing system metrics. As an option, one or more variations of curved band display scenario 5A00 or any aspect thereof may be implemented in the context of the architecture and functionality of the embodiments described herein. The curved band display scenario 5A00 or any aspect thereof may be implemented in any environment.

FIG. 5A illustrates one aspect pertaining to assigning computing system metrics to curved bands having graphical characteristics that represent the states of the metrics. Specifically, the figure is being presented to illustrate how certain band assignment attributes and metric state parameters are combined into programming objects that are interpreted (e.g., by a browser) to display the curved bands and their graphical characteristics. More specifically, FIG. 5A depicts a set of select band assignment attributes 502 and a set of select metric state parameters 504 that are accessed by UI display engine 124 to generate a set of HTML programming objects 426 for displaying a metric state view 1142 at user interface 104.

As can be observed, the curved bands of the highest level group (e.g., “group=1” referenced in the first four rows (e.g., “order=1”, “order=2”, “order=3”, and “order=4”) of select band assignment attributes 502 correspond to the four curved bands (e.g., curved band label “1”, “2”, “3”, and “4”, respectively) presented in metric state view 114₂. The curved bands are also of various lengths as defined, for example, by the “startPos” and “endPos” attributes of the curved bands (not shown). The select metric state parameters 504 are mapped to the select band assignment attributes 502 by the unique identifier in the respective “metricID” fields. The foregoing mapping is used by UI display engine 124 to determine certain graphical characteristics of the curved bands based at least in part on the then-current “value” and “status” of the corresponding system metrics. For example, a graphical characteristic 1442 (e.g., a value fill) for curved band “4” represents the value (e.g., “value=50” percent) associated with system metric “09u5 . . . ”. Another graphical characteristic 144₃ (e.g., band fill) is applied by UI display engine 124 to the remainder of curved band “4”. A graphical characteristic 144₄ (e.g., status alert) is also generated to indicate a status (e.g., “status=blocked” for the underlying operation associated with curved band “4”. As shown, UI display engine 124 might also generate programming objects to display a legend 522 that describes certain curved band attributes, metric state parameters, and/or other information. In some cases, an interior area 524 of the innermost curved band might be used for various purposes. For example, interior area 524 might display some high order metric, such as a system health metric.

The foregoing discussions include techniques for interacting with the displayed curved bands, which techniques are disclosed in further detail as follows.

FIG. 5B and FIG. 5C present a curved band subcomponent drill down scenario 550 as implemented in systems that use curved bands to display computing system metrics. As an option, one or more variations of curved band subcomponent drill down scenario 550 or any aspect thereof may be implemented in the context of the architecture and functionality of the embodiments described herein. The curved band subcomponent drill down scenario 550 or any aspect thereof may be implemented in any environment.

FIG. 5B and FIG. 5C illustrate one aspect pertaining to assigning computing system metrics to curved bands having graphical characteristics that represent the states of the metrics. Specifically, the figures are being presented to illustrate a scenario in which a curved band is selected to drill down to the details of the subcomponents (e.g., system metrics and/or computing processes and/or computing resources) that are associated with the selected curved band.

As shown in FIG. 5B, the metric state view 114₂ earlier described is presented to user 102 at user interface 104. Upon viewing the metric state view 114₂, the user 102 might, for example, desire to drill down on curved band “4” to investigate the status alert. Responsive to user 102 clicking (or double-clicking) on curved band “4”, a curved band selection event 552 is received at UI display engine 124. The band assignments are accessed to identify any child groups associated with the selected curved band. As indicated in the select band assignment attributes 502, a child group (e.g., “child=2”) is associated with the selected curved band (e.g., “bandID=d8gd . . . ”). The curved bands and corresponding metric state parameters (e.g., from select metric state parameters 504) associated with the child group (e.g., “group=2”) are accessed by UI display engine 124 to generate the programming objects used to present a metric state drill down view 514₁. As can be observed, the metric state drill down view 514₁ comprises two curved bands (e.g., curved band label “T1” and “T2”) that correspond to the two band-metric pairs associated with group “2” in select band assignment attributes 502. The interior area of the innermost curved band of metric state drill down view 514₁ is used to summarize the issue (e.g., “Task T2 is stranded!”) associated with the displayed system metrics.

Various graphical representations can be implemented to display the underlying child metrics of a parent system metric. As shown in FIG. 5C, bar-shaped graphical elements are implemented in a metric state drill down view 514₂ at user interface 104 to indicate the then-current state (e.g., value and status) of the underlying tasks (e.g., task “T1” and task “T2”) associated with the higher order operation represented in band “4” of metric state view 114₂.

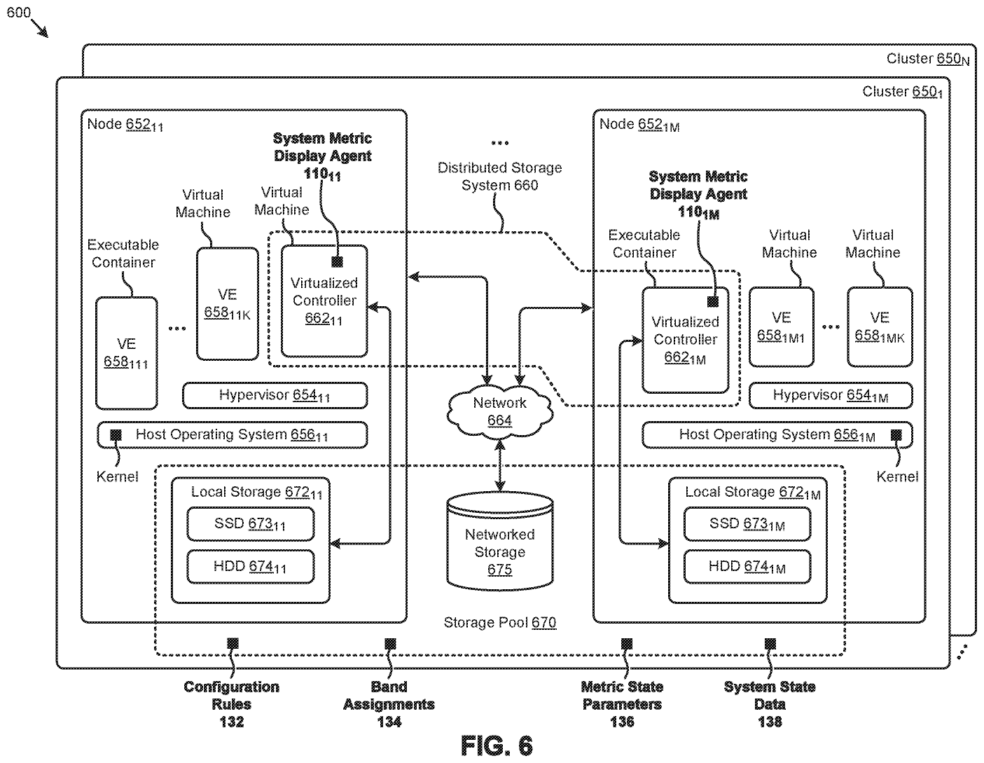

An example of a distributed computing environment (e.g., distributed virtualization environment, etc.) that supports any of the herein disclosed techniques is presented and discussed as pertains to FIG. 6.

FIG. 6 presents a distributed virtualization environment 600 in which embodiments of the present disclosure can be implemented. As an option, one or more variations of distributed virtualization environment 600 or any aspect thereof may be implemented in the context of the architecture and functionality of the embodiments described herein.

FIG. 6 illustrates one aspect pertaining to assigning computing system metrics to curved bands having graphical characteristics that represent the states of the metrics. Specifically, the figure presents a logical depiction of how the herein disclosed techniques can be implemented in a distributed virtualization environment to display various system metrics associated with the environment in the form of a set of curved bands.

The shown distributed virtualization environment depicts various components associated with instances of distributed virtualization systems (e.g., hyperconverged distributed systems) that can be used to implement the herein disclosed techniques. Specifically, the distributed virtualization environment 600 comprises multiple clusters (e.g., cluster 650₁, . . . , cluster 650N) comprising multiple nodes that have multiple tiers of storage in a storage pool. Representative nodes (e.g., node 652₁₁, . . . , node 652_{1M}) and storage pool 670 associated with cluster 650₁ are shown. Each node can be associated with one server, multiple servers, or portions of a server. The nodes can be associated (e.g., logically and/or physically) with the clusters. As shown, the multiple tiers of storage include storage that is accessible through a network 664, such as a networked storage 675 (e.g., a storage area network or SAN, network attached storage or NAS, etc.). The multiple tiers of storage further include instances of local storage (e.g., local storage 672₁₁, . . . , local storage 672_{1M}). For example, the local storage can be within or directly attached to a server and/or appliance associated with the nodes. Such local storage can include solid state drives (SSD 673₁₁, . . . , SSD 673_{1M}), hard disk drives (HDD 674₁₁, . . . , HDD 674_{1M}), and/or other storage devices.

As shown, any of the nodes of the distributed virtualization environment 600 can implement one or more user virtualized entities (e.g., VE 658₁₁₁, . . . , VE 658_{11K}, . . . , VE 658_{1M1}, . . . , VE 658_{1MK}), such as virtual machines (VMs) and/or executable containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 656₁₁, . . . , host operating system 656_{1M}), while the VMs run multiple applications on various respective guest operating systems. Such flexibility can be facilitated at least in part by a hypervisor (e.g., hypervisor 654₁₁, . . . , hypervisor 654_{1M}), which hypervisor is logically located between the various guest operating systems of the VMs and the host operating system of the physical infrastructure (e.g., node).

As an alternative, executable containers may be implemented at the nodes in an operating system-based virtualization environment or container virtualization environment. The executable containers are implemented at the nodes in an operating system virtualization environment or container virtualization environment. The executable containers comprise groups of processes and/or resources (e.g., memory, CPU, disk, etc.) that are isolated from the node host computer and other containers. Such executable containers directly interface with the kernel of the host operating system (e.g., host operating system 656₁₁, . . . , host operating system 656_{1M}) without, in most cases, a hypervisor layer. This lightweight implementation can facilitate efficient distribution of certain software components, such as applications or services (e.g., micro-services). Any node of a distributed virtualization environment 600 can implement both a hypervisor-assisted virtualization environment and a container virtualization environment for various purposes. Also, any node in a distributed virtualization environment can implement a virtualized controller to facilitate access to storage pool 670 by the VMs and/or the executable containers.

As used in these embodiments, a virtualized controller is a collection of software instructions that serve to abstract details of underlying hardware or software components from one or more higher-level processing entities. A virtualized controller can be implemented as a virtual machine, as an executable container (e.g., a Docker container), or within a layer (e.g., such as a layer in a hypervisor).

Multiple instances of such virtualized controllers can coordinate within a cluster to form the distributed storage system 660 which can, among other operations, manage the storage pool 670. This architecture further facilitates efficient scaling in multiple dimensions (e.g., in a dimension of computing power, in a dimension of storage space, in a dimension of network bandwidth, etc.).

The foregoing virtualized controllers can be implemented in the distributed virtualization environment using various techniques. As one specific example, an instance of a virtual machine at a given node can be used as a virtualized controller in a hypervisor-assisted virtualization environment to manage storage and I/O (input/output or IO) activities. In this case, for example, the virtualized entities at node 652₁₁ can interface with a controller virtual machine (e.g., virtualized controller 662₁₁) through hypervisor 654₁₁ to access the storage pool 670. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 660. For example, a hypervisor at one node in the distributed storage system 660 might correspond to software from a first vendor, and a hypervisor at another node in the distributed storage system 660 might correspond to a second software vendor. As another virtualized controller implementation example, executable containers (e.g., Docker containers) can be used to implement a virtualized controller (e.g., virtualized controller 662_{1M}) in an operating system virtualization environment at a given node. In this case, for example, the virtualized entities at node 652_{1M} can access the storage pool 670 by interfacing with a controller container (e.g., virtualized controller 662_{1M}) through hypervisor 654_{1M} and/or the kernel of host operating system 656_{1M}.

In certain embodiments, one or more instances of a system metric display agent can be implemented in the distributed storage system 660 to facilitate the herein disclosed techniques. Specifically, system metric display agent 110₁₁ can be implemented in the virtualized controller 662₁₁, and system metric display agent 110_{1M} can be implemented in the virtualized controller 662_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents (e.g., system metric display agent). As further shown, instances of configuration rules 132, band assignments 134, metric state parameters 136, system state data 138, and/or other data sets can be stored in storage pool 670 to facilitate the herein disclosed techniques.

As earlier described, the problems attendant to compactly displaying the states of multiple heterogenous computing system metrics can be addressed in the context of the foregoing environment. Moreover, any aspect or aspects of assigning computing system metrics to curved bands having graphical characteristics that represent the states of the metrics can be implemented in the context of the foregoing environment.

### Additional Embodiments of the Disclosure

### Additional Practical Application Examples

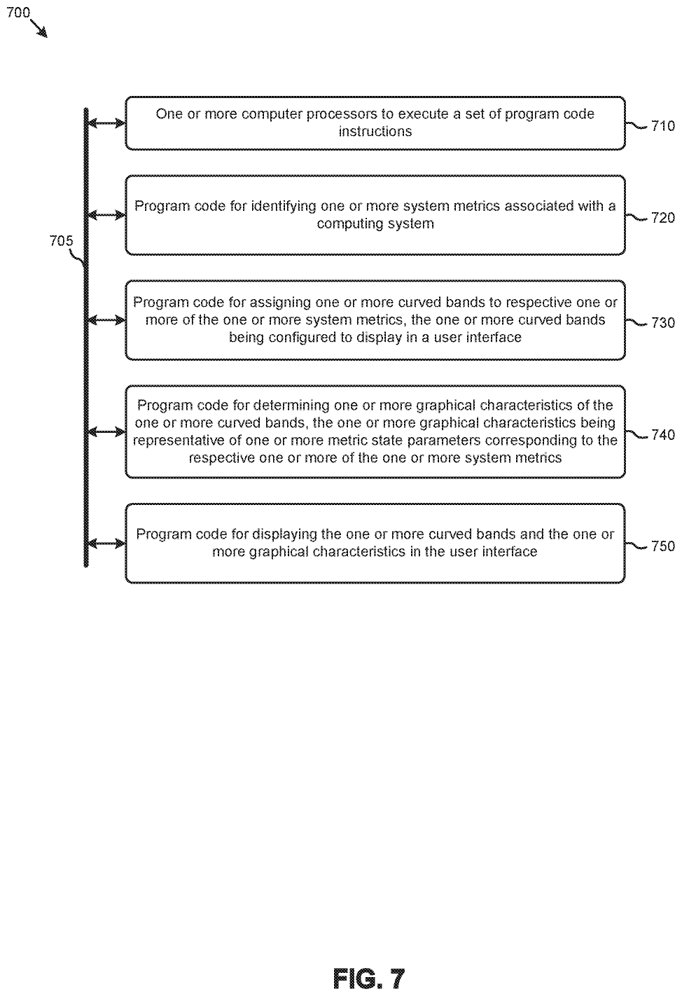

FIG. 7 depicts a system 700 as an arrangement of computing modules that are interconnected so as to operate cooperatively to implement certain of the herein-disclosed embodiments. This and other embodiments present particular arrangements of elements that, individually and/or as combined, serve to form improved technological processes that address compactly displaying the states of multiple heterogenous computing system metrics. The partitioning of system 700 is merely illustrative and other partitions are possible. As an option, the system 700 may be implemented in the context of the architecture and functionality of the embodiments described herein. Of course, however, the system 700 or any operation therein may be carried out in any desired environment. The system 700 comprises at least one processor and at least one memory, the memory serving to store program instructions corresponding to the operations of the system. As shown, an operation can be implemented in whole or in part using program instructions accessible by a module. The modules are connected to a communication path 705, and any operation can communicate with other operations over communication path 705. The modules of the system can, individually or in combination, perform method operations within system 700. Any operations performed within system 700 may be performed in any order unless as may be specified in the claims. The shown embodiment implements a portion of a computer system, presented as system 700, comprising one or more computer processors to execute a set of program code instructions (module 710) and modules for accessing memory to hold program code instructions to perform: identifying one or more system metrics associated with a computing system (module 720); assigning one or more curved bands to respective one or more of the one or more system metrics, the one or more curved bands being non-circle shapes having two ends, and wherein the curved bands are configured to display in a user interface (module 730); determining one or more graphical characteristics of the one or more curved bands, the one or more graphical characteristics being representative of one or more metric state parameters corresponding to the respective one or more of the one or more system metrics (module 740); and displaying the one or more curved bands and the one or more graphical characteristics in the user interface (module 750).

Variations of the foregoing may include more or fewer of the shown modules. Certain variations may perform more or fewer (or different) steps and/or certain variations may use data elements in more or in fewer (or different) operations.

### System Architecture Overview

### Additional System Architecture Examples

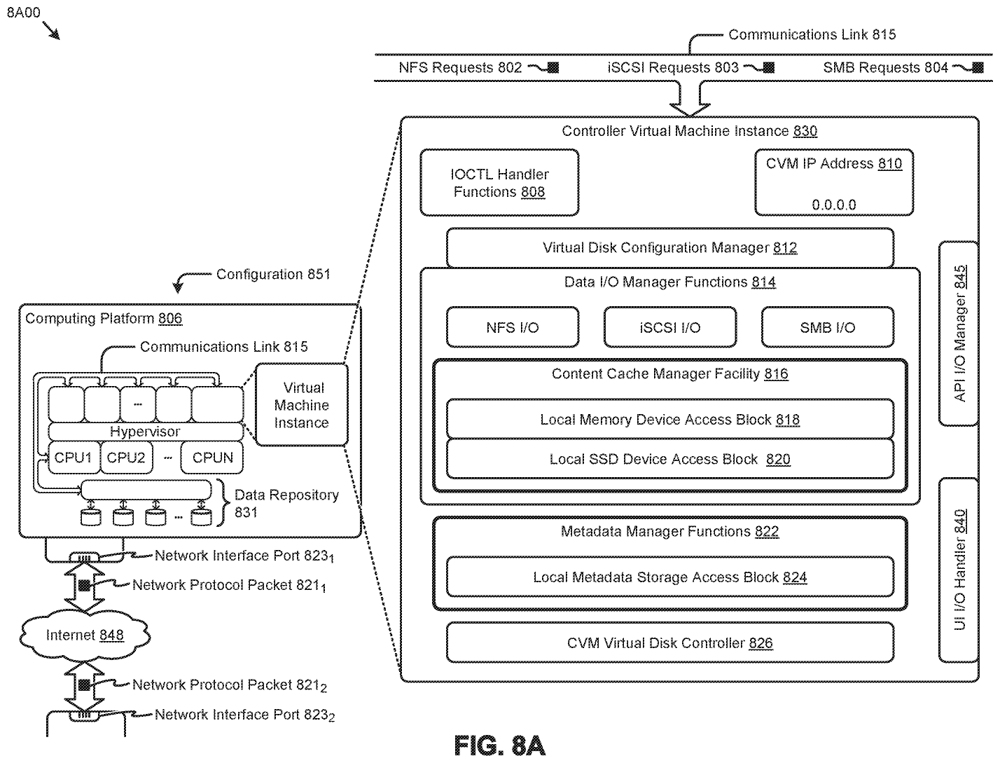

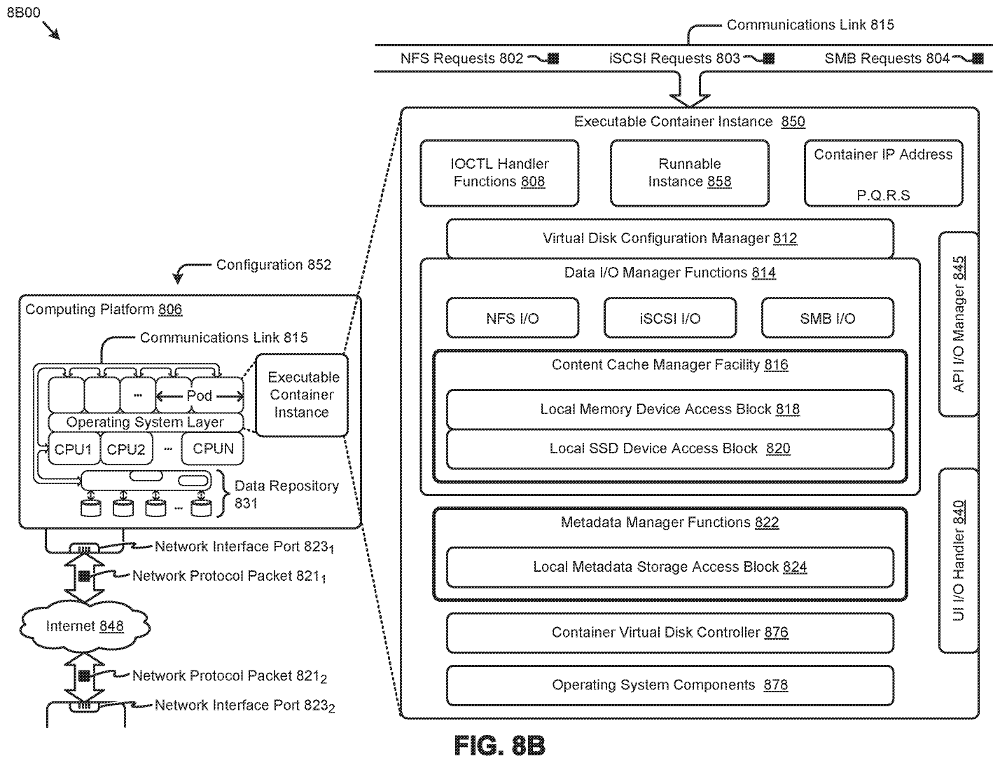

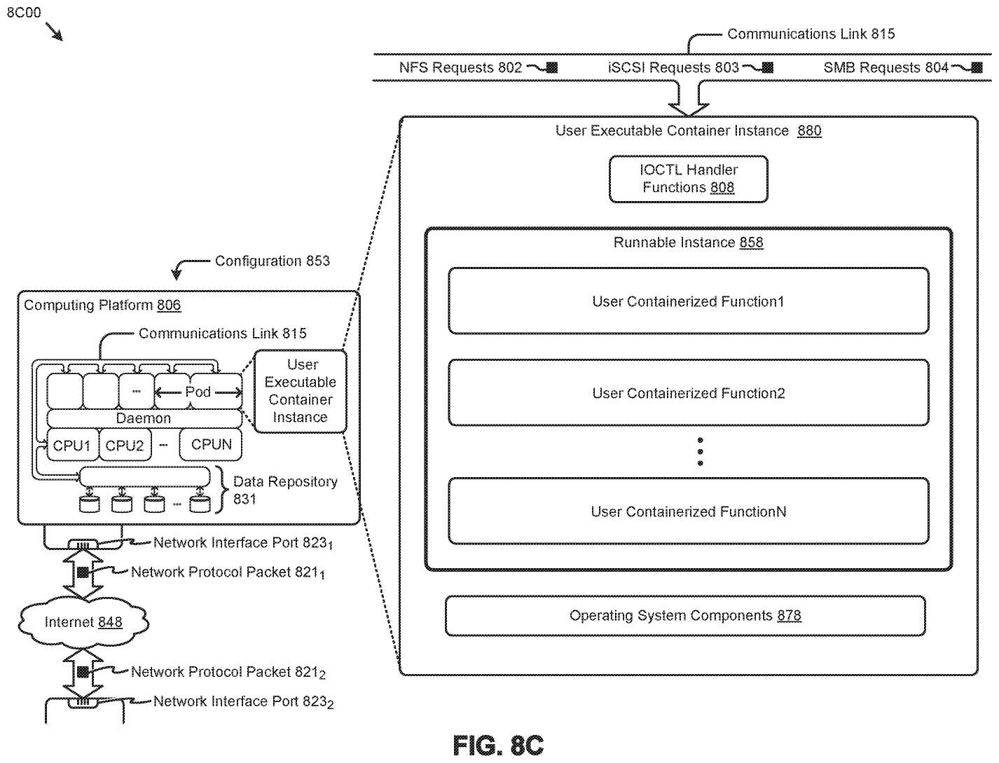

FIG. 8A depicts a virtualized controller as implemented by the shown virtual machine architecture 8A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high performance computing, high performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 8A00 comprises a collection of interconnected components suitable for implementing embodiments of the present disclosure and/or for use in the herein-described environments. Moreover, virtual machine architecture 8A00 includes a virtual machine instance in configuration 851 that is further described as pertaining to controller virtual machine instance 830. Configuration 851 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 830.

In this and other configurations, a controller virtual machine instance receives block I/O (input/output or IO) storage requests as network file system (NFS) requests in the form of NFS requests 802, and/or internet small computer storage interface (iSCSI) block IO requests in the form of iSCSI requests 803, and/or Samba file system (SMB) requests in the form of SMB requests 804. The controller virtual machine (CVM) instance publishes and responds to an internet protocol (IP) address (e.g., CVM IP address 810). Various forms of input and output (I/O or IO) can be handled by one or more IO control handler functions (e.g., IOCTL handler functions 808) that interface to other functions such as data IO manager functions 814 and/or metadata manager functions 822. As shown, the data IO manager functions can include communication with virtual disk configuration manager 812 and/or can include direct or indirect communication with any of various block IO functions (e.g., NFS IO, iSCSI IO, SMB IO, etc.).

In addition to block IO functions, configuration 851 supports IO of any form (e.g., block IO, streaming IO, packet-based IO, HTTP traffic, etc.) through either or both of a user interface (UI) handler such as UI IO handler 840 and/or through any of a range of application programming interfaces (APIs), possibly through API IO manager 845.

Communications link 815 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or persistent random access memories (RAPMs) or optical or magnetic media drives such as paper tape or magnetic tape drives. Volatile media includes dynamic memory such as random access memory. As shown, controller virtual machine instance 830 includes content cache manager facility 816 that accesses storage locations, possibly including local dynamic random access memory (DRAM) (e.g., through local memory device access block 818) and/or possibly including accesses to local solid state storage (e.g., through local SSD device access block 820).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 831, which in turn can be formatted into any one or more storage areas, and which can comprise parameterized storage accessible by a key (e.g., a filename, a table name, a block address, an offset address, etc.). External data repository 831 can store any forms of data, and may comprise a storage area dedicated to storage of metadata pertaining to the stored forms of data. In some cases, metadata can be divided into portions. Such portions and/or cache copies can be stored in the external storage data repository and/or in a local storage area (e.g., in local DRAM areas and/or in local SSD areas). Such local storage can be accessed using functions provided by local metadata storage access block 824. External data repository 831 can be configured using CVM virtual disk controller 826, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 851 can be coupled by communications link 815 (e.g., backplane, LAN, PSTN, wired or wireless network, etc.) and each instance may perform respective portions of sequences of instructions as may be required to practice embodiments of the disclosure.

The shown computing platform 806 is interconnected to the Internet 848 through one or more network interface ports (e.g., network interface port 823₁ and network interface port 823₂). Configuration 851 can be addressed through one or more network interface ports using an IP address. Any operational element within computing platform 806 can perform sending and receiving operations using any of a range of network protocols, possibly including network protocols that send and receive packets (e.g., network protocol packet 821₁ and network protocol packet 821₂).

Computing platform 806 may transmit and receive messages that can be composed of configuration data and/or any other forms of data and/or instructions organized into a data structure (e.g., communications packets). In some cases, the data structure includes program code instructions (e.g., application code) communicated through the Internet 848 and/or through any one or more instances of communications link 815. Received program code may be processed and/or executed by a CPU as it is received and/or program code may be stored in any volatile or non-volatile storage for later execution. Program code can be transmitted via an upload (e.g., an upload from an access device over the Internet 848 to computing platform 806). Further, program code and/or the results of executing program code can be delivered to a particular user via a download (e.g., a download from computing platform 806 over the Internet 848 to an access device).

Configuration 851 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to using curved bands to display computing system metrics. In some embodiments, a module may include one or more state machines and/or combinational logic used to implement or facilitate the operational and/or performance characteristics pertaining to using curved bands to display computing system metrics.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of using curved bands to display computing system metrics). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to using curved bands to display computing system metrics, and/or for improving the way data is manipulated when performing computerized operations pertaining to assigning computing system metrics to curved bands having graphical characteristics that represent the states of the metrics.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 8B depicts a virtualized controller implemented by containerized architecture 8B00. The containerized architecture comprises a collection of interconnected components suitable for implementing embodiments of the present disclosure and/or for use in the herein-described environments. Moreover, the shown containerized architecture 8B00 includes an executable container instance in configuration 852 that is further described as pertaining to executable container instance 850. Configuration 852 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 850). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container or as a controller executable container. Any executable container of any sort can be rooted in a directory system, and can be configured to be accessed by file system commands (e.g., “1s” or “1s−a”, etc.). The executable container might optionally include operating system components 878, however such a separate set of operating system components need not be provided. As an alternative, an executable container can include runnable instance 858, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 876. Such a container virtual disk controller can perform any of the functions that the aforementioned CVM virtual disk controller 826 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 8C depicts a virtualized controller implemented by a daemon-assisted containerized architecture 8C00. The containerized architecture comprises a collection of interconnected components suitable for implementing embodiments of the present disclosure and/or for use in the herein-described environments. Moreover, the shown daemon-assisted containerized architecture includes a user executable container instance in configuration 853 that is further described as pertaining to user executable container instance 880. Configuration 853 includes a daemon layer (as shown) that performs certain functions of an operating system.

User executable container instance 880 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 858). In some cases, the shown operating system components 878 comprise portions of an operating system, which portions are interfaced with or included in the runnable instance and/or any user containerized functions. In this embodiment of a daemon-assisted containerized architecture, the computing platform 806 might or might not host operating system components other than operating system components 878. More specifically, the shown daemon might or might not host operating system components other than operating system components 878 of user executable container instance 880.

The virtual machine architecture 8A00 of FIG. 8A and/or the containerized architecture 8B00 of FIG. 8B and/or the daemon-assisted containerized architecture 8C00 of FIG. 8C can be used in any combination to implement a distributed platform that contains multiple servers and/or nodes that manage multiple tiers of storage where the tiers of storage might be formed using the shown external data repository 831 and/or any forms of network accessible storage. As such, the multiple tiers of storage may include storage that is accessible over communications link 815. Such network accessible storage may include cloud storage or networked storage (e.g., a SAN or “storage area network”). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices, such as SSDs or RAPMs, or hybrid HDDs or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term vDisk refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 851 of FIG. 8A) to manage the interactions between the underlying hardware and user virtual machines or containers that run client software.

Distinct from user virtual machines or user executable containers, a special controller virtual machine (e.g., as depicted by controller virtual machine instance 830) or as a special controller executable container is used to manage certain storage and I/O activities. Such a special controller virtual machine is referred to as a “CVM”, or as a controller executable container, or as a service virtual machine “SVM”, or as a service executable container, or as a “storage controller”. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method comprising:
assigning a plurality of curved bands to corresponding system metrics associated with a computing system, the plurality of curved bands being configured to display in a user interface, wherein at least one of the curved bands has a first end and a second end, and wherein the first end and the second end are positioned at different locations in the user interface;
determining graphical characteristics of the plurality of curved bands, the graphical characteristics being representative of metric state parameters corresponding to respective system metrics; and
displaying the plurality of curved bands and the graphical characteristics in the user interface.

2. The method of claim 1, further comprising determining at least one of the metric state parameters based at least in part on system state data.

3. The method of claim 1, further comprising displaying a second set of curved bands in response to a selection event.

4. The method of claim 1, further comprising determining a band attribute associated with at least one of the plurality of curved bands.

5. The method of claim 4, wherein at least one of the graphical characteristics is based at least in part on at least one of the band attributes.

6. The method of claim 4, wherein at least one of the band attributes corresponds to at least one of, a band order, a color, a fill pattern, a start position, an end position, or a ratio.

7. The method of claim 1, wherein the plurality of curved bands are assigned to respective system metrics based at least in part on at least one of, a metric type, a curved band type, or a scale attribute.

8. The method of claim 7, wherein the scale attribute is determined based at least in part on a scaling rule.

9. The computer readable medium of claim 11, wherein at least one of the graphical characteristics is changed in response to changes associated with at least one of the metric state parameters.

10. The computer readable medium of claim 11, wherein the graphical characteristics are codified in one or more HTML programming objects.

11. A non-transitory computer readable medium having stored thereon a sequence of instructions which, when executed by a processor causes a set of acts comprising;
assigning a plurality of curved bands to corresponding system metrics associated with a computing system, the plurality of curved bands being configured to display in a user interface, wherein at least one of the curved bands has a first end and a second end, and wherein the first end and the second end are positioned at different locations in the user interface;
determining graphical characteristics of the plurality of curved bands, the graphical characteristics being representative of metric state parameters corresponding to respective system metrics; and
displaying the plurality of curved bands and the graphical characteristics in the user interface.

12. The computer readable medium of claim 11, the set of acts further comprising determining at least one of the metric state parameters based at least in part on system state data.

13. The computer readable medium of claim 11, the set of acts further comprising displaying a second set of curved bands in response to a selection event.

14. The computer readable medium of claim 11, the set of acts determining a band attribute associated with at least one of the plurality of curved bands.

15. The computer readable medium of claim 14, wherein at least one of the graphical characteristics is based at least in part on at least one of the band attributes.

16. The computer readable medium of claim 14, wherein at least one of the band attributes corresponds to at least one of, a band order, a color, a fill pattern, a start position, an end position, or a ratio.

17. The computer readable medium of claim 11, wherein the plurality of curved bands are assigned to respective system metrics based at least in part on at least one of, a metric type, a curved band type, or a scale attribute.

18. The computer readable medium of claim 17, wherein the scale attribute is determined based at least in part on a scaling rule.

19. A system comprising:
a storage medium having stored thereon a sequence of instructions; and
a processor that executes the sequence of instructions to perform a set of acts comprising:
assigning a plurality of curved bands to corresponding system metrics associated with a computing system, the plurality of curved bands being configured to display in a user interface, wherein at least one of the curved bands has a first end and a second end, and wherein the first end and the second end are positioned at different locations in the user interface;
determining graphical characteristics of the plurality of curved bands, the graphical characteristics being representative of metric state parameters corresponding to respective system metrics; and
displaying the plurality of curved bands and the graphical characteristics in the user interface.

20. The system of claim 19, wherein the plurality of curved bands are assigned to respective system metrics based at least in part on at least one of, a metric type, a curved band type, or a scale attribute.
